(19) United States
(12) Patent Application Publication
(10) Pub. No.: US 2010/0091839 A1
(43) Pub. Date: Apr. 15, 2010

(54) Flexible redundancy coding

(76) Inventors: Zhenyu Wu, Plainsboro, NJ (US); Jill MacDonald Boyce, Manalapan, OR (US)

Correspondence Address: Robert D. Shedd, Patent Operations;THOMSON Licensing LLC, P.O. Box 5312, Princeton, NJ, 08543-5312, US

(21) Appl. No.: 12/311,391

(22) PCT Filed: Sep. 28, 2006
(86) PCT No.: PCT/US2006/038184

§ 371 Date: Dec. 4, 2009

(51) Int. Cl. H04N 7/12

(52) U.S. Cl. 375/240.02; 375/E07.026

(57) ABSTRACT

Various disclosed implementations allow a flexible amount of redundancy to be used in coding. In one general implementation, information is accessed for determining which of multiple encodings of at least a portion of a data object to send over a channel. A set of multiple encodings is determined for sending over the channel, with the set including at least one and possibly more of the multiple encodings, and the number of encodings in the set being based on the accessed information. In a more particular implementation, the redundant slice feature of the H.264/AVC coding standard is used, and a variable number of redundant slices is transmitted for any given picture based on current channel conditions.

### TECHNICAL FIELD

This disclosure relates to data coding.

### BACKGROUND OF THE INVENTION

Coding systems often provide redundancy so that transmitted data can be received and decoded despite the presence of errors. Particular systems provide, in the context of video for example, multiple encodings for a particular sequence of pictures. These systems also transmit all of the multiple encodings. A receiver that receives the transmitted encodings may be able to use the redundant encodings to correctly decode the particular sequence even if one or more of the encodings is lost or received with errors.

### SUMMARY

According to an implementation, information is accessed for determining which of multiple encodings of at least a portion of a data object to send over a channel, and a set of encodings to send over the channel is determined. The set is determined from the multiple encodings and includes at least one and possibly more than one of the multiple encodings. The number of encodings in the determined set is based on the accessed information.

According to another implementation, information is provided for determining which of multiple encodings of at least a portion of a data object to send over a channel. A set of encodings is received over the channel, with the set having been determined from the multiple encodings and including at least one and possibly more than one of the multiple encodings. The number of encodings in the set is based on the provided information.

The details of one or more implementations are set forth in the accompanying drawings and the description below. Other aspects and features will become apparent from the following detailed description considered in conjunction with the accompanying drawings and the claims. It is to be understood, however, that the drawings are designed solely for purposes of illustration and not as a definition of the limits of the present principles. It should be further understood that the drawings are not necessarily drawn to scale and that, unless otherwise indicated, they are merely intended to conceptually illustrate particular structures and procedures.

### BRIEF DESCRIPTION OF THE DRAWINGS

FIG. 1 includes a block diagram of a system for sending and receiving encoded data.

FIG. 2 includes a block diagram of another system for sending and receiving encoded data.

FIG. 3 includes a flow chart of a process for selecting encodings with the systems of FIGS. 1 and 2.

FIG. 4 includes a flow chart of a process for receiving encodings with the systems of FIGS. 1 and 2.

FIG. 5 includes a flow chart of a process for sending encodings with the system of FIG. 2.

FIG. 6 includes a pictorial representation of multiple encodings for each of N pictures.

FIG. 7 includes a pictorial representation of encodings selected from the representation of FIG. 6.

FIG. 8 includes a flow chart of a process for processing received encodings with the system of FIG. 2.

FIG. 9 includes a block diagram of a system for sending and receiving encoded data using layers.

FIG. 10 includes a flow chart of a process for sending encodings with the system of FIG. 9.

FIG. 11 includes a pictorial representation of the encodings of FIG. 6 ordered into layers according to the process of FIG. 10.

### DETAILED DESCRIPTION

An implementation is directed to video-encoding using the H.264/AVC (Advanced Video Coding) standard promulgated by the ISO (“International Standards Organization”) and the MPEG (“Moving Picture Experts Group”) standards bodies. The H.264/AVC standard describes a “redundant slice” feature allowing a particular picture, for example, to be encoded multiple times, thus providing redundancy. Using the “redundant slice” feature, the particular picture may be encoded a first time as a “primary coded picture” (“PCP”) and one or more additional times as one or more “redundant coded pictures” (“RCPs”). A coded picture, either a PCP or an RCP, may include multiple slices, but for purposes of simplicity we typically use these terms interchangeably, as if the coded picture included only a single slice.

The above implementation encodes the particular picture ahead of time creating a PCP as well as multiple RCPs. When a transmission of the particular picture is requested, for example, by a user requesting a download over the Internet, a transmitter accesses these coded pictures. The transmitter also accesses information describing, for example, the current error rate on the path to the user. Based on the current error rate, the transmitter determines which of the multiple RCPs to send to the user, along with the PCP. The transmitter may determine, for example, to send only one RCP if the error rate is low, but to send all of the multiple RCPs if the error rate is high.

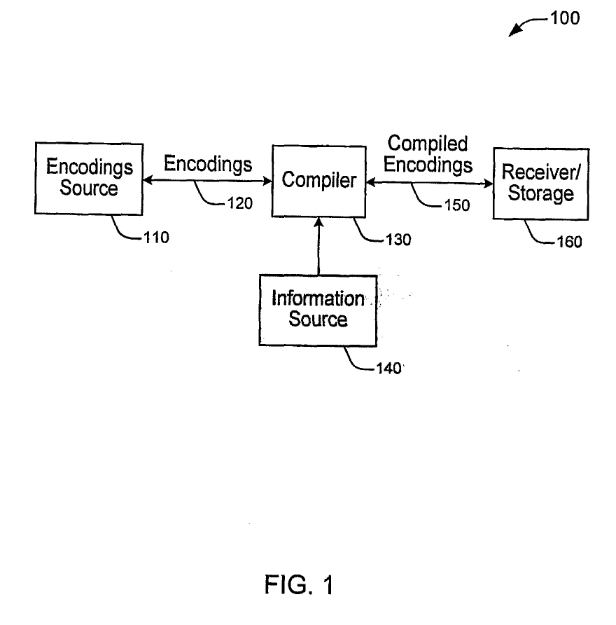

FIG. 1 shows a block diagram of a system 100 for sending and receiving encoded data. The system 100 includes an encodings source 110 supplying encodings over a path 120 to a compiler 130. The compiler 130 receives information from an information source 140, and provides a compiled stream of encodings over a path 150 to a receiver/storage device 160.

The system 100 may be implemented using any of a variety of different coding standards or methods, and need not comply with any standard. For example, the source 110 may be a personal computer or other computing device coding data using various different motion estimation coding techniques, or even block codes. The source 110 also may be, for example, a storage device storing encodings that were encoded by such a computing device. However, for clarity and completeness in description, much of this application describes particular implementations that use the H.264/AVC coding standard. Despite the details and focus of those implementations on the H.264/AVC standard, other implementations are contemplated that do not use any standard, much less the H.264/AVC standard.

The compiler 130 receives from the source 110 multiple encodings for a given data unit. The compiler 130 selects at least some of the multiple encodings to send to the receiver/storage device 160, and compiles the selected encodings in order to send the selected encodings to the receiver/storage device 160. In many implementations, the compiler 130 compiles and sends encodings in response to a request, or after receiving a request.

Such a request may be received from, for example, the source 110, the receiver/storage device 160, or from another device not shown in the system 100. Such other devices may include, for example, a web server listing encodings available on the source 110 and providing users access to the listed encodings. In such an implementation, the web server may connect to the compiler 130 to request that encodings be sent to the receiver/storage device 160 where a user may be physically located. The receiver/storage device 160 may provide the user with, for example, a high definition display for viewing encodings (for example, videos) that are received, and a browser for selecting videos from the web server.

The compiler 130 also may compile and send encodings without a request. For example, the compiler 130 may simply compile and send encodings in response to receiving a stream of encodings from the source 110. As a further example, the compiler 130 may compile and send encodings at a fixed time every evening in order to provide a daily compiled stream of the day's news events, and the stream may be pushed to a variety of recipients.

The compiler 130 bases the selection of encodings to compile and send, at least in part, on information received from the information source 140. The received information may relate to one or more of various factors including, for example, (1) quality of service, or a type of service, expected or desired for the given data unit, (2) capacity (bits or bandwidth, for example) allocated to the given data unit, (3) error rate (bit error rate or packet error rate, for example) on the path (also referred to as a channel) to the receiver/storage device 160, and (4) capacity available on the path to the receiver/storage device 160. Many factors relate to channel conditions (also referred to as channel performance), such as, for example, error rate or capacity. The information source 140 may be, for example, (1) a control unit monitoring the path 150, (2) a quality-of-service manager that may be, for example, local to the compiler 130, or (3) a look-up table included in the compiler 130 providing target bit rates for various data units.

The compiler 130 may use the information from the information source 140 in a variety of manners. For example, if the error rate is below a threshold, the compiler 130 may determine to compile and send only half of the available encodings for the given data unit. Conversely, if the error rate is at or above the threshold, the compiler 130 may determine to compile and send all of the available encodings for the given data unit.

The receiver/storage device 160 may be, for example, any device capable of receiving the compiled encodings sent by the compiler 130. For example, the receiver/storage device 160 may include one or more of various commonly available storage devices, including, for example, a hard disk, a server disk, or a portable storage device. In various implementations, the compiled encodings are sent directly to storage after compilation, for later display or further transmission. The receiver/storage device 160 also may be, for example, a computing device capable of receiving encoded data and processing the encoded data. Such computing devices may include, for example, set-top boxes, coders, decoders, or codecs. Such computing devices also may be part of or include, for example, a video display device such as a television. Such a receiver may be designed to receive data transmitted according to a particular standard.

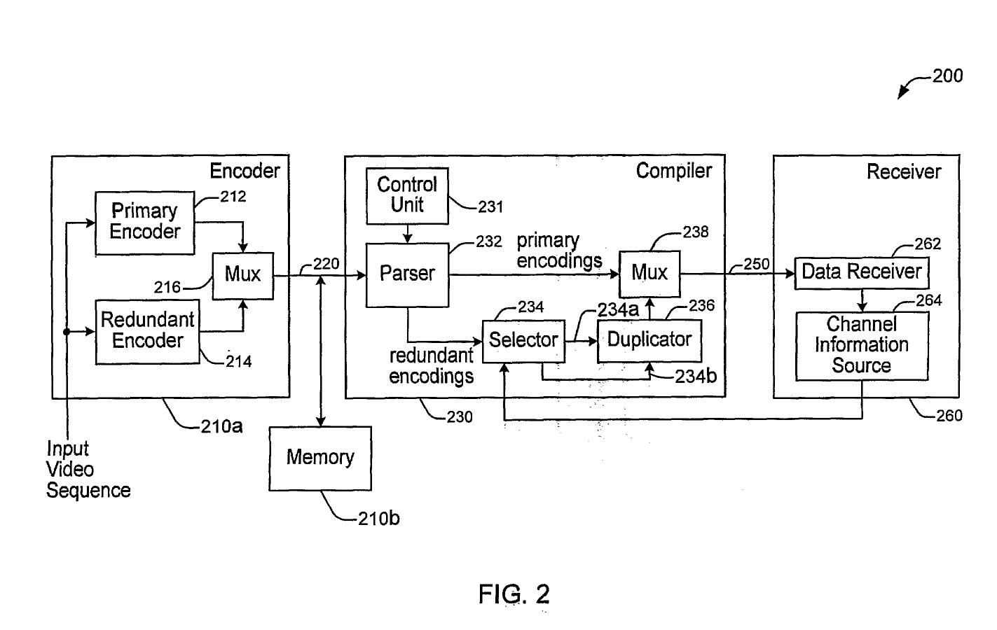

FIG. 2 shows a block diagram of a system 200 for sending and receiving encoded data. The system 200 corresponds to a particular implementation of the system 100. The system 200 includes two possible sources of encodings which are an encoder 210a and a memory 210b. Both of these sources are connected to a compiler 230 over a path 220, and the compiler 230 is further connected over a path 250 to a receiver 260. The paths 220 and 250 are analogous to the paths 120 and 150.

The encoder 210a receives an input video sequence and includes a primary encoder 212 and a redundant encoder 214. The primary encoder 212 creates primary encodings for each of the pictures (or other data units) in the input video sequence, and the redundant encoder 214 creates one or more redundant encodings for each of the pictures in the input video sequence. Note that a picture may include, for example, a field or a frame. The encoder 210a also includes a multiplexer 216 that receives, and multiplexes, both the primary encoding and the one or more redundant encodings for each picture. The multiplexer 216 thus creates a multiplexed stream, or signal, of encodings for the input video sequence. The multiplexed stream is provided to either, or both, the memory 210b or the compiler 230.

The compiler 230 receives a stream of encodings from either, or both, the encoder 210a or the memory 210b. The compiler 230 includes a parser 232, a selector 234, a duplicator 236, and a multiplexer 238 connected in series. The parser 232 is also connected to a control unit 231, and connected directly to the multiplexer 238. Further, the selector 234 has two connections to the duplicator 236, including a stream connection 234a and a control connection 234b. Analogous to the compiler 130, the compiler 230 selects at least some of the multiple encodings to send to the receiver 260, and compiles the selected encodings in order to send the selected encodings to the receiver 260. Further, the compiler 230 bases the selection, at least in part, on information received from the receiver 260.

The control unit 231 receives a request to send one or more encodings. Such a request may come from, for example, the encoder 210a, the receiver 260, or a device not shown in the system 200. Such a device may include, for example, a web server as previously described. For example, the control unit 231 may receive a request from the encoder 210a over the path 220, or may receive a request from the receiver 260 over the path 250, or may receive a self-generated request from a timed event as previously described. Once a request is received, the control unit 231 passes along the request to the parser 232, and the parser 232 requests the corresponding stream of encodings from either the encoder 210a or the memory 210b.

Implementations of the system 200 need not provide a request or use the control unit 231. For example, the parser 232 may simply compile and send encodings upon receipt of a stream of encodings from the encoder 210a.

The parser 232 receives the stream from the encoder 210a and separates the received stream into a sub-stream for the primary encodings and a sub-stream for the redundant encodings. The redundant encodings are provided to the selector 234.

The selector 234 also receives information from the receiver 260 describing the current conditions of the path 250. Based on the information received from the receiver 260, the selector 234 determines which of the redundant encodings to include in the stream of encodings that will be sent to the receiver 260. The selected redundant encodings are output from the selector 234 on the stream connection 234a to the duplicator 236, and the non-selected redundant encodings are not sent.

In one implementation, the selector 234 receives from the receiver 260 information indicating the available capacity on the path 250, and the selector 234 selects all redundant encodings until the capacity is full. For example, the information may indicate that the path 250 has a capacity of 2 Mbps (megabits/second) at the present time. The capacity may be variable, for example, due to variable use by other compilers (not shown). Assuming, for example, that the compiler 230 dedicates 1 Mbps to the primary encodings, the selector 234 may then dedicate the remaining 1 Mbps to the redundant encodings. Further, the selector 234 may then select redundant encodings until the 1 Mbps bandwidth is filled. For example, to fill the 1 Mbps bandwidth, the selector 234 may allocate to the redundant encodings four slots in a time-division multiple access scheme in which each slot is given 250 kbps.

The selector 234 also may select a given redundant encoding twice. For example, suppose a given picture has been allocated 1 Mbps for redundant encodings, and the particular picture has only two redundant encodings that have a bandwidth requirement of 1,200 kbps and 500 kbps. The selector 234 may determine that the second redundant encoding should be sent twice so as to use the entire 1 Mbps. To achieve this, the selector 234 sends the second redundant encoding in the stream over the stream connection 234a to the duplicator 236, and also sends a control signal to the duplicator 236 over the control connection 234b. The control signal instructs the duplicator 236 to duplicate the second redundant encoding and to include the duplicated encoding in the stream that the duplicator 236 sends to the multiplexer 238.

The receiver 260 includes a data receiver 262 connected to a channel information source 264. The data receiver 262 receives the stream of encodings sent from the compiler 230 over the path 250, and the data receiver 262 may perform a variety of functions. Such functions may include, for example, decoding the encodings, and displaying the decoded video sequence. Another function of the data receiver 262 is to determine channel information to provide to the channel information source 264. The channel information provided to the channel information source 264, from the data receiver 262, indicates current conditions of the path 250. This information may include, for example, an error rate such as a bit-error-rate or a packet-error-rate, or capacity utilization such as the data rate that is being used or the data rate that is still available. The channel information source 264 provides this information to the selector 234 as previously described. The channel information source 264 may provide this information over the path 250 or over another path, such as, for example, a back-channel or an auxiliary channel.

The system 200 is not specific to any particular encoding algorithm, much less to an entire standard. However, the system 200 may be adapted to the H.264/AVC standard. In one such implementation, the encoder 210a is adapted to operate as an H.264/AVC encoder by, for example, adapting the primary encoder 212 to create PCPs and adapting the redundant encoder 214 to create RCPs. Further, in that implementation the parser 232 is adapted to parse the PCPs into a sub-stream sent directly to the multiplexer 238, and to parse the RCPs into a sub-stream sent to the selector 234. Additionally, in that implementation the receiver 260 is adapted to operate as an H.264/AVC decoder, in addition to providing the channel information.

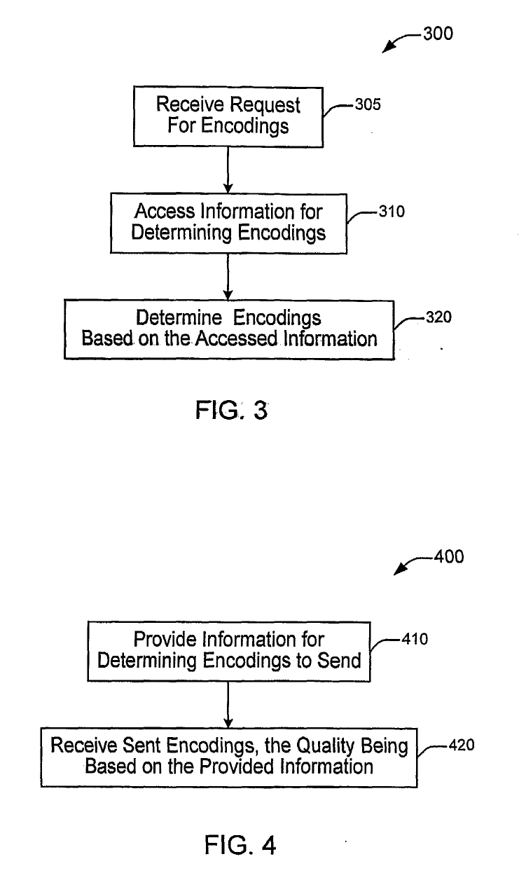

FIGS. 3 and 4 present flow charts of processes for using the systems 100 and 200. These flow charts will be described briefly and then various aspects will be explained in greater detail in conjunction with further Figures.

FIG. 3 shows a flow chart describing a process 300 that can be performed by each of the systems 100 and 200. The process 300 includes receiving a request to send over a channel one or more encodings of at least a portion of a data object (305). For example, in the system 100 the compiler 130 may receive a request to send encodings to the receiver/storage device 160. As another example, in the system 200 the control unit 231 of the compiler 230 may receive a request to send encodings to the receiver 260.

The process 300 further includes accessing information for determining, or selecting, which of multiple encodings of at least a portion of a data object to send over a channel (310). The information is typically accessed after receiving the request in operation 305, and the information may be accessed in response to receiving the request. For example, in the system 100 the compiler 130 accesses information provided by the information source 140, and in the system 200 the selector 234 accesses channel information provided by the channel information source 264.

The process 300 further includes determining, based on the accessed information, a set of the multiple encodings to send over the channel (320). The set is determined from the multiple encodings, includes at least one and possibly more than one of the multiple encodings. Further, the number of encodings in the set is based on the accessed information. For example, in the system 100 the compiler 130 selects which of the encodings to send over the path 150, and the quantity of encodings selected depends on the accessed information. As another example, in the system 200 the selector 234 selects which of the redundant encodings to send over the path 250, and the quantity selected depends on the accessed channel information. In many implementations, the quantity will be at least two. However, the quantity may be zero or one in other implementations.

The compiler 130 may include, for example, a data server, a personal computer, a web server, a video server, or a video encoder. In many implementations, different portions of the compiler 130 perform the different operations of the process 300, with the different portions including the hardware and software instructions needed to perform the specific operation. Thus, for example, a first portion of a video server may receive the request (305), a second portion of the video server may access the information (310), and a third portion of the data server may determine the set of encodings to send (320).

FIG. 4 shows a flow chart describing a process 400 that can be performed by each of the systems 100 and 200. The process 400 includes providing information for determining which of multiple encodings of at least a portion of a data object to send over a channel (410). For example, in the system 100 the information source 140 provides such information to the compiler 130, and in the system 200 the channel information source 264 provides such information to the selector 234.

The process 400 further includes receiving over the channel a set of encodings of at least the portion of the data object (420). The set of encodings includes at least one and possibly more than one of the multiple encodings. Further, the number of encodings in the set is based on the information provided in operation 410. For example, in the system 100 the receiver/storage device 160 receives over the path 150 a set of encodings determined and sent by the compiler 130. Further, the compiler 130 selects the encodings in the set based on the information received from the information source 140. As another example, in the system 200 the receiver 260 receives over the path 250 a quantity of encodings in a set selected and sent by the compiler 230. Further, the compiler 230 determines the encodings to include in the set based on the information received from the channel information source 264.

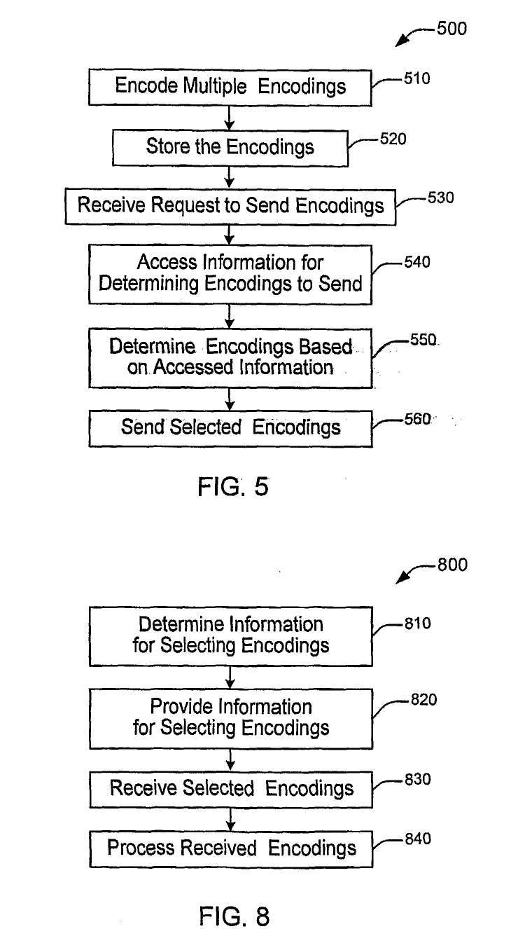

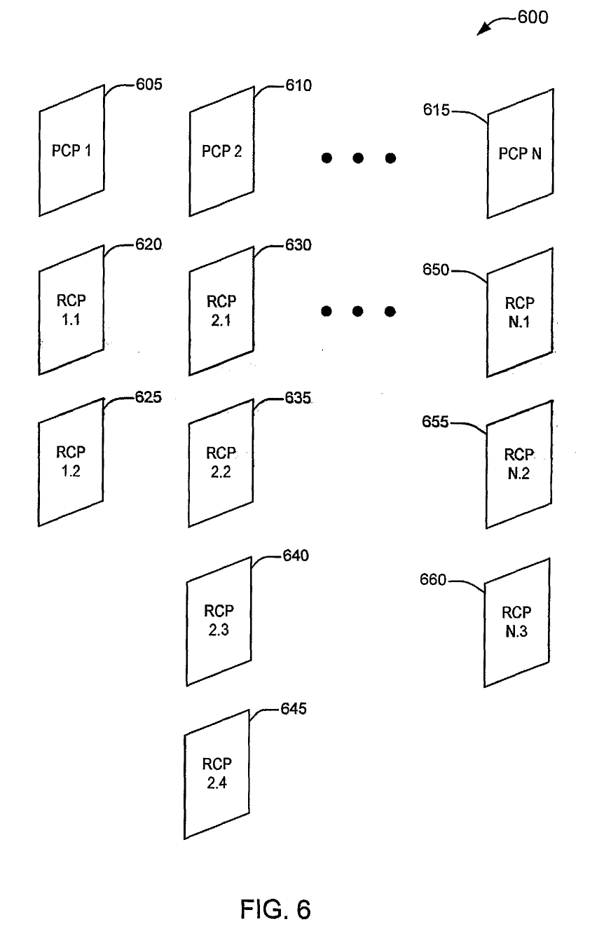

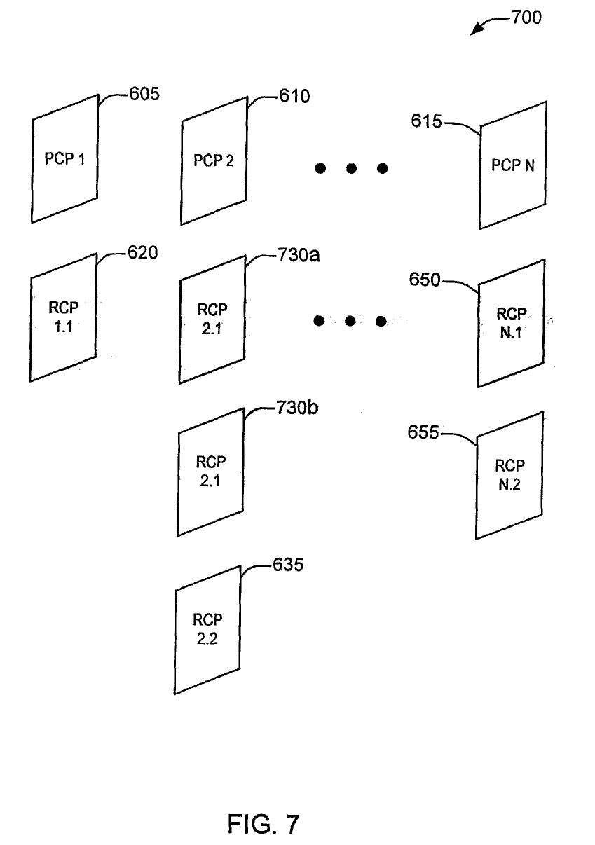

FIGS. 5 and 8 present further processes for using the system 200. FIGS. 6-7 present diagrams that will be explained in conjunction with FIGS. 5 and 8.

FIG. 5 shows a flow chart describing a process 500 that can be performed by the system 200. The process 500 includes encoding multiple encodings for each picture in a data unit, such as, for example, a group of pictures (“GOP”), or just a single picture (510). In system 200, the encoder 210a creates multiple encodings for each picture in a data unit' using the primary encoder 212 and the redundant encoder 214. An example of multiple encodings is shown in FIG. 6.

FIG. 6 includes a pictorial representation 600 of multiple encodings for each of N pictures. The encodings may be created according to the H.264/AVC standard to produce the PCPs and RCPs. For each picture, a PCP and multiple RCPs are shown. Specifically, the PCPs shown include a PCP 1 (605), a PCP 2 (610), and a PCP N (615). Further, the RCPs shown include (1) an RCP 1.1 (620) and an RCP 1.2 (625), corresponding to the PCP 1 (605), (2) an RCP 2.1 (630), an RCP 2.2 (635), an RCP 2.3 (640), and an RCP 2.4 (645), corresponding to the PCP 2 (610), and (3) an RCP N.1 (650), an RCP N.2 (655), and an RCP N.3 (660), corresponding to the PCP N (615). The coded pictures may be created using one or more of a variety of coding techniques.

The multiple encodings shown in the representation 600, as well as the encodings in many other implementations, are source-encodings. Source-encodings are encodings that compress the data being encoded, as compared with channel-encodings which are encodings that add additional information that is typically used for error correction or detection. Thus, in implementations in which multiple source-encodings are sent for a given picture, the multiple source-encodings provide source-coding redundancy. Redundancy is valuable, for example, when lossy channels are used as occurs with many of the video transmission implementations discussed herein.

The process 500 further includes storing the multiple encodings (520). The encodings may be stored, for example, on any of a variety of storage devices. As with many of the operations in the process 500, and the other processes disclosed in this application, operation 520 is optional. Storing is optional in the process 500 because, for example, in other implementations the multiple encodings are processed by, for example, a compiler, directly after being created. In the system 200, the multiple encodings may be stored in the memory 210b.

The process 500 includes receiving a request to send encodings of the picture, or pictures, in the data unit (530). In the system 200, a request to send encodings may be received by the control unit 231 as previously described.

The process 500 includes accessing channel information for determining which of the multiple prepared encodings of the picture, or pictures, in the data unit to send over the path 250 (540). The process 500 further includes determining a set of encodings to send over the path 250, with the determined set including at least one and possibly more of the multiple encodings, and the number of encodings in the set being based on the accessed channel information (550). Operations 540 and 550 are analogous to operations 310 and 320 in the process 300, and performance of operations 310 and 320 by the system 200 has been explained in, for example, the discussion above of operations 310 and 320. A further explanation will be provided, however, using FIG. 7.

FIG. 7 includes a pictorial representation 700 of the selected encodings for each of N pictures. The selected encodings have been selected from the encodings shown in the representation 600. As shown in the representation 700, all PCPs are selected. That is, the PCP 1 (605), the PCP 2 (610), and the PCP N (615) are selected. However, not all of the RCPs available in the representation 600 are selected. Specifically, (1) for the PCP 1 (605), the RCP 1.1 (620) is selected, but the RCP 1.2 (625) is not selected, (2) for the PCP 2 (610), the RCP 2.1 (630) and the RCP 2.2 (635) are selected, but the RCP 2.3 (640) and the RCP 2.4 (645) are not selected, and (3) for the PCP N (615), the RCP N.1 (650) and the RCP N.2 (655) are selected, but the RCP N.3 (660) is not selected. Additionally, the RCP 2.1 (630) is selected twice, so that the RCP 2.1 (630) will appear two times in a final multiplexed stream of encodings. The two selections of the RCP 2.1 (630) are designated with reference numerals 730a and 730b in the representation 700.

FIG. 7 shows the result of the selection process for one example, but FIG. 7 does not describe why some encodings were selected and others were not. Various criteria may be used for determining which of the possible encodings to select. For example, the encodings may be selected in the order received for a given picture until a bit constraint for that picture is used. As another example, a value of a distortion metric may be calculated for each encoding, and all encodings having a distortion value below a particular threshold may be selected. Appendix A describes the selection process for another implementation.

The process 500 further includes sending the selected encodings (560). As described earlier, the encodings may be sent, for example, to a storage device or a processing device. In the system 200, the compiler 230 sends the multiplexed stream of encodings from the multiplexer 238 over the path 250 to the receiver 260. Many implementations send the encodings by forming a stream that includes the selected encodings.

It should be clear that the amount of source-encoding redundancy that is provided can vary for different pictures. The amount of source-encoding redundancy can vary due to, for example, different numbers of source-encodings being selected. Different numbers of source-encodings may be selected for different pictures because, for example, the source-encodings for different pictures having different sizes or the accessed information being different for different pictures.

FIG. 8 shows a flow chart describing a process 800 that can be performed by the receiver 260 of the system 200. The process 800 includes determining channel information for use in determining which of multiple encodings to send over a channel (810), and then providing that information (820). In the system 200, the data receiver 262 determines channel information indicating current conditions of the channel and provides this channel information to the channel information source 264. The channel information source 264 then provides the channel information to the selector 234. Operation 820 of the process 800 is analogous to operation 410 of the process 400.

The process 800 further includes receiving over the channel a set, or a quantity, of encodings (830). The set includes one, and possibly more, of the multiple encodings. The quantity of encodings in the set having been selected based on the provided channel information and then sent over the channel. Operation 830 of the process 800 is analogous to operation 420 of the process 400, and an example of the system 200 performing operation 420 was provided above in the discussion of operation 420. The process 800 further includes processing the received encodings (840). Examples of processing include decoding the encodings, displaying the decoded encodings, and sending the received encodings or the decoded encodings to another destination.

In one implementation, the system 200 adheres to the H.264/AVC standard. The H.264/AVC standard defines a variable called “redundantpic_count” which is zero for a PCP and is non-zero for an RCP. Further, the variable is incremented for each RCP that is associated with a given PCP. Thus, the receiver 260 is able to determine, for each picture, whether any particular received encoding is an RCP or a PCP. For each picture, the receiver 260 may then decode and display the encoding with the lowest value for the variable “redundant_pic_count”. However, other implementations may combine multiple coded-pictures that are received without error.

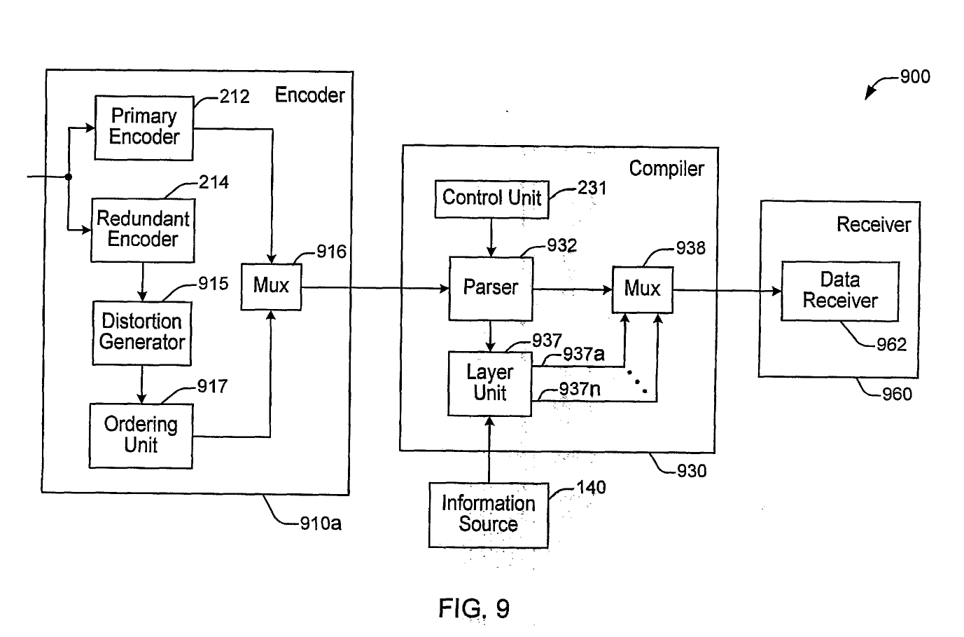

FIGS. 9-11 relate to another implementation that organizes encodings into layers and provides error resilience. FIG. 9 shows a block diagram of a system 900 that includes an encoder 910a that provides encodings to a compiler 930, and the compiler 930 provides compiled encodings to a receiver 960. The system 900 further includes the information source 140. The structure and operation of the system 900 is largely analogous to that of the system 200, with corresponding reference numerals generally having at least some corresponding functions. Accordingly, identical features will not necessarily be repeated, and the discussion of the system 900 that follows focuses on the differences from the system 200.

The encoder 910a includes the primary encoder 212 and the redundant encoder 214. The encoder 910a further includes a distortion generator 915 that receives encodings from the redundant encoder 214, generates a value of a distortion metric for each encoding, and provides each encoding and the distortion value for each encoding to an ordering unit 917. The ordering unit 917 orders the encodings based on the generated distortion values, and provides the ordered encodings to a multiplexer 916. The multiplexer 916 is analogous to the multiplexer 216 and multiplexes the ordered redundant encodings and the primary encodings into an output stream that is provided to the compiler 930.

The compiler 930 includes the control unit 231 connected to a parser 932 that provides input to both a layer unit 937 and a multiplexer 938. The layer unit 937 also provides input to the multiplexer 938. The compiler 930 receives the stream of encodings from the encoder 910a and provides a compiled stream of encodings to the receiver 960.

The parser 932 is analogous to the parser 232, and separates the received stream into primary encodings that are provided directly to the multiplexer 938 and secondary encodings that are provided to the layer unit 937. More specifically, the parser 932 separates the received stream into a base layer for the primary encodings and a sub-stream for the redundant encodings. The parser 932 provides the base layer to the multiplexer 938, and provides the sub-stream of redundant encodings to the layer unit 937.

The sub-stream of redundant encodings that the layer unit 937 receives includes redundant encodings that have been ordered by the ordering unit 917. The layer unit 937 separates the sub-stream of redundant encodings into one or more layers, referred to as enhancement layers, and provides the enhancement layers to the multiplexer 938 as needed. As shown in FIG. 9, the layer unit 937 has “n” outputs 937a-937n, one for each enhancement layer. If an implementation only requires one enhancement layer, then the layer unit 937 would only need one output for enhancement layers, and would provide the single enhancement layer on output 937a. Systems may include multiple outputs 937a-n, however, providing flexibility for various implementations that may require different numbers of layers.

The layer unit 937 also receives input from the information source 140 and uses this information in a manner analogous to that described for the compiler 130's use of the information from the information source 140, as well as the selector 234's use of the channel information from the channel information source 264. In particular, the layer unit 937 may use the information from the information source 140 to determine how many enhancement layers to create.

Several implementations of the compiler 930 operate on discrete sets of pictures. For example, one video implementation operates on a GOP. In that implementation, the parser 932 provides a separate base layer to the multiplexer 938 for each GOP, and the layer unit 937 provides separate enhancement layers for each GOP.

The receiver 960 is generally analogous to the receiver 160, and includes a data receiver 962 that receives the multiplexed stream from the multiplexer 938. The data receiver 962 is analogous to the receiver 262, and may perform a variety of functions. Such functions may include, for example, decoding the encodings, and displaying or otherwise providing the decoded encodings to an end user.

The system 900 is not specific to any particular encoding algorithm, much less to an entire standard. However, the system 900 may be adapted to the H.264/AVC standard. In one such implementation, the encoder 910a is adapted to operate as an H.264/AVC encoder by, for example, adapting the primary encoder 212 to create PCPs and adapting the redundant encoder 214 to create RCPs. Further, the parser 932 is adapted to parse the PCPs into a sub-stream sent directly to the multiplexer 938, and to parse the RCPs into a sub-stream sent to the layer unit 937. Additionally, the receiver 960 is adapted to operate as an H.264/AVC decoder.

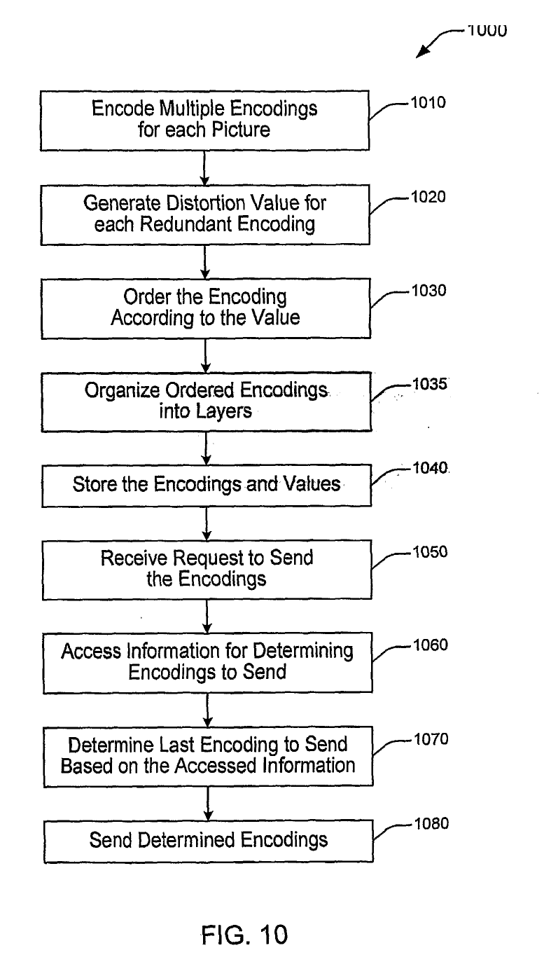

FIG. 10 provides a flow diagram of an implementation of a process 1000 for operating the system 900 in a video environment. The process 1000 includes encoding multiple encodings, including a primary encoding and one or more redundant encodings, for each picture in a video sequence (1010). Operation 1010 is analogous to operation 510 in the process 500. In FIG. 9, the primary encoder 212 and the redundant encoder 214 may create the encodings for operation 1010. In one implementation, the created encodings may include the encodings shown in the pictorial representation 600.

The process 1000 includes generating, or otherwise determining, a value of a distortion metric for each of the redundant encodings (1020). The distortion metric may be any metric, or measure, for example, for ranking the encodings according to some measure of quality. One such measure, determined for each given encoding, is the mean-squared error (“MSE”) between the given encoding and the original picture. Another such measure is the peak signal-to-noise ratio (“PSNR”) for the given encoding. In many implementations, the MSE is calculated between a decoded picture and the original picture, and typically averaged across a group of pictures to produce a metric referred to as the average MSE. In many implementations, the PSNR for an encoding is calculated from the MSE as a logarithmic function of the MSE for that encoding, as is well known. The set of PSNRs for a set of encodings may be averaged by summing and dividing, as is well known; to produce the average PSNR. However, the average PSNR may alternatively be calculated directly from the average MSE by using the same logarithmic function used to calculate PSNR for an individual encoding. The alternate computation of the average PSNR puts more weight on decoded pictures that have large distortion, and this weight tends to more accurately reflect the quality variation perceived by an end user viewing the decoded pictures. Other distortion metrics also may be used.

The process 1000 includes ordering the encodings based on the generated distortion value for each encoding (1030), and organizing the ordered encodings into layers (1035). The ordering unit 917 may perform both the ordering and the layering. In one implementation, the ordering occurs by rearranging the redundant encodings so that they are in increasing order of distortion value (higher distortion values are expected to result in decodings that are of poorer quality). The rearranging may be, for example, physical rearranging or logical rearranging. Logical rearranging includes, for example, creating a linked list out of the encodings, with each encoding in a layer pointing to the next encoding in its layer.

Further, the layering may occur by allotting a certain number of bits to each layer of redundant encodings, and then filling the layers with the ordered encodings such that each layer is filled before moving on to fill a successive layer. In another implementation, the layering may occur by dividing the stream of encodings into layers based on the values of the distortion metric. For example, all redundant encodings with a distortion value between certain endpoints may be put into a common layer.

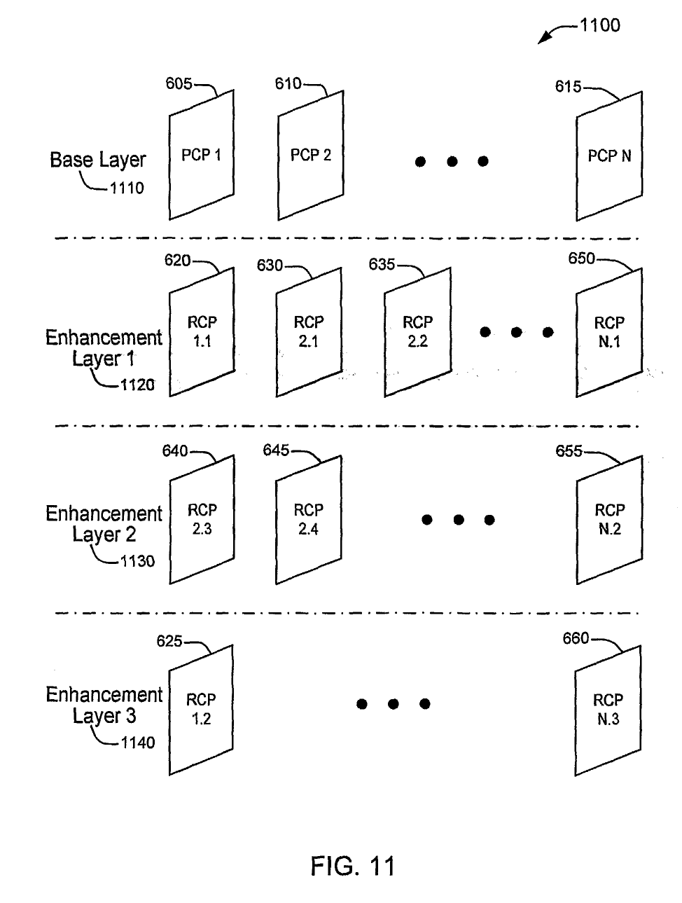

FIG. 11 provides a pictorial representation 1100 of the encodings from the representation 600 after the encodings have been ordered into multiple layers according to an implementation of the process 1000. Specifically, the representation 1100 shows that the encodings have been organized into four layers, including a Base Layer 1110, an Enhancement Layer 1 1120, an Enhancement Layer 2 1130, and an Enhancement Layer 3 1140.

The Base Layer 1110 includes all of the PCPs for a given GOP. The PCPs shown are the PCP 1 (605), the PCP 2 (610), and the PCP N (615). The Enhancement Layer 1 1120 is the first layer of redundant encodings and includes the RCP 1.1 (620), the RCP 2.1 (630), the RCP 2.2 (635), and the RCP N.1 (650). The Enhancement Layer 2 1130 is the second layer of redundant encodings and includes the RCP 2.3 (640), the RCP 2.4 (645), and the RCP N.2 (655). The Enhancement Layer 3 1140 is the third layer of redundant encodings and includes the RCP 1.2 (625) and the RCP N.3 (660). In this implementation, the Enhancement Layers are organized in order of increasing distortion values, such that the “better” redundant encodings are included in the earlier Enhancement Layers.

Referring again to Appendix A, there is shown an implementation for selecting encodings based on distortion values. That implementation can be extended to order a set of encodings across an entire GOP, for example, rather than merely order a set of encodings for a given picture. In one such extension, the expected values of the distortion reduction are determined with respect to the entire GOP rather than a single picture, and the expected values of distortion reduction are optimized across all encodings for the GOP rather than just the encodings for the single picture. It is also noted that in Appendix A the expected values of distortion for a sequence are based on the calculated distortion values for individual encodings in the sequence.

The process 1000 includes storing the encodings and the distortion values (1040). This operation, as with many in the process 1000, is optional. Operation 1040 is analogous to operation 520 in the process 500. Implementations may, for example, retrieve previously stored encodings. Conversely, implementations may receive currently generated encodings.

The process 1000 includes receiving a request to send one or more encodings for a given picture (1050). The process 1000 further includes accessing information for determining the encodings to send for the given picture (1060), determining the last encoding to send based on the accessed information (1070), and sending the selected encodings (1080). Operations 1050, 1060, 1070, and 1080 are analogous to operations 530-560 in the process 500, respectively.

In one implementation, the information accessed in operation 1060 from the information source 140 is used to determine how many bits can be used for sending the encodings of a given picture. Because the redundant encodings are already ordered by their distortion values, the order presumably represents the preference for which redundant encodings to select and to send. Accordingly, for the given picture, the primary encoding is selected and included in the set of encodings to send, and all of the redundant encodings are selected, in order, until the available number of bits has been used. It may occur that, for a given picture, there are some bits left over that are not used by the selected encodings, but that those left-over bits are not enough to send the next encoding in the ordered set of encodings for the given picture. One method of resolving such a scenario is to either round up or down, effectively deciding to give the extra bits to the next picture's encodings or to take some bits away from the next picture's encodings. Accordingly, in this implementation, encodings are selected by determining how many bits are available and then terminating the stream of ordered encodings at the determined bit value (perhaps rounding up or down). Thus, a quantity of encodings is selected by selecting the encoding at which to terminate the stream. That is, a quantity of encodings is selected by selecting a “last” encoding to send. The selected encodings are included in the set of encodings to send.

In the above implementation, the operation (1070) of determining the last encoding to send may also be performed by simply selecting how many layers to send. For example, if the implementation has already determined the number of bits for sending the encodings of a given picture, the process may terminate the stream of ordered encodings at the end of the layer in which the determined bit value falls. Thus, if the Base Layer and each Enhancement Layer requires 1000 bits, and the information accessed from the information source 140 indicates that 2700 bits are available, then one implementation selects the Base Layer and the first two Enhancement Layers to send. Because 3000 bits would be used, this implementation may also subtract 300 bits from the next picture's bit allotment.

In the above implementation, as with many implementations, multiple slices may be used to encode a given RCP. In a typical implementation, all of those slices will be put into the same layer to ensure that all (or none) of the slices for that RCP are sent. However, in some implementation all of the slices for a given RCP are not put into the same layer.

In another implementation, the encodings are organized into layers (1035) only after selecting which encodings to send (1070). For example, in the system 900, the layer unit 937 may organize the encodings into layers. This implementation may offer advantages of flexibility because the information accessed from the information source 140 can be used in determining the layer sizes. Additionally, the layer unit 937 could also generate the distortion values for the encodings and perform the ordering. By generating the distortion values in the layer unit 937, the layer unit 937 may have the advantage of having already accessed information from the information source 140. The accessed information may allow, for example, the layer unit 937 to generate distortion values that take into consideration the available number of bits (or layers, or encodings) that can be sent.

Implementations of the process 1000 may also provide error resilience scalability to the stream of encodings. To provide error resilience scalability, it is desired, that the stream has an incremental increase in error resilience as the number of encodings in the stream is increased. That is, the expected value of a measure of error (or distortion, for example) goes down as more encodings are sent. Considering video environments, and H.264/AVC implementations in particular, one particular error-resilient scalable implementation first sends the PCPs for the pictures of a GOP, and then sends the RCPs. As more encodings are sent, starting with the PCPs and continuing with the RCPs, the error-resilience of the GOP is increased because the implementation has a higher likelihood of correctly decoding the GOP. Additionally, if the encodings have been ordered according to increasing distortion values, then the string of encodings that are selected for any given picture may be optimal, or close to optimal, for the bit rate being used. It should be clear that error-resilience scalability can be provided with or without layers.

The system 900 can also be modified such that various operations are optional by selecting a mode. For example, a user may indicate that distortion values are not needed, and the system may disable the distortion generator 915 and the ordering unit 917. The user may also indicate that layering is not needed, and the system may cause the layer unit 937 to operate as the selector 234 and the duplicator 236. Further, it should be clear that in one implementation, a system can be caused to operate as, for example, either the system 200 or the system 900, with the use, for example, of switches to enable or disable various features that are specific to either the system 200 or the system 900.

It should also be clear that the functions of the duplicator 236 could be implemented in the layer unit 937, for example, such that particular encodings could be duplicated and included in a layer. For example, if there are unused bits after selecting a layer, then the last layer could be extended by duplicating one or more encodings.

Many implementations are compliant with the H.264/AVC standard, although all implementations do not need to be compliant with the H.264/AVC standard or any other standard. Further, many implementations are described using terms associated with the H.264/AVC standard, such as, for example, “primary coded picture”, “redundant coded picture”, and “redundant slice”. However, the use of such terms does not imply that the implementation is, or needs to be, compliant with the H.264/AVC standard. Those terms are used in a general sense, independent of the H.264/AVC standard, and do not incorporate the H.264/AVC standard or any other standard. Further yet, those terms may be used with other standards, including future standards, and the implementations are intended to be applicable with all such standards.

Implementations also may operate by accessing information from the information source 140 and then creating the desired encodings rather than selecting from among prepared encodings. These implementations may have the advantage of, for example, being more flexible in meeting particular bit rate constraints.

As described earlier, many implementations determine a set of encodings to send, wherein the determination is based on accessed information. In many implementations, determining the set, with the determination being based on accessed information, will be equivalent to selecting the quantity of encodings, with the quantity being based on accessed information. However, implementations may exist in which the two features differ. Additionally, in implementations that access information for selecting which of multiple encodings to send over a channel, the information may be accessed in response to a request to send over the channel one or more encodings of at least the portion of the data object.

Implementations may optimize on a variety of different factors in lieu of, or in addition to, distortion. Such other factors include, for example, the cost of sending data over a given channel at a given quality.

Paths (for example, the path 110) can be direct if the path has no intervening elements, or indirect which allows for intervening elements. If two elements are stated to be “coupled”, the two elements may be coupled, or connected, either directly or indirectly. Further, a coupling need not be physical, such as, for example, when two elements are communicatively coupled across free space through various routers and repeaters (for example, two cell phones).

Implementations of the various processes and features described herein may be embodied in a variety of different equipment or applications, particularly, for example, equipment or applications associated with video transmission. Examples of equipment include video codecs, web servers, cell phones, portable digital assistants (“PDAs”), set-top boxes, laptops, and personal computers. As should be clear from these examples, encodings may be sent over a variety of paths, including, for example, wireless or wired paths, the Internet, cable television lines, telephone lines, and Ethernet connections.

The various aspects, implementations, and features may be implemented in one or more of a variety of manners, even if described above without reference to a particular manner or using only one manner. For example, the various aspects, implementations, and features may be implemented using, for example, one or more of (1) a method (also referred to as a process), (2) an apparatus, (3) an apparatus or processing device for performing a method, (4) a program or other set of instructions for performing one or more methods, (5) an apparatus that includes a program or a set of instructions, and (6) a computer readable medium.

An apparatus may include, for example, discrete or integrated hardware, firmware, and software. As an example, an apparatus may include, for example, a processor, which refers to processing devices in general, including, for example, a microprocessor, an integrated circuit, or a programmable logic device. As another example, an apparatus may include one or more computer readable media having instructions for carrying out one or more processes.

A computer readable medium may include, for example, a software carrier or other storage device such as, for example, a hard disk, a compact diskette, a random access memory (“RAM”), or a read-only memory (“ROM”). A computer readable medium also may include, for example, formatted electromagnetic waves encoding or transmitting instructions. Instructions may be, for example, in hardware, firmware, software, or in an electromagnetic wave. Instructions may be found in, for example, an operating system, a separate application, or a combination of the two. A processor may be characterized, therefore, as, for example, both a device configured to carry out a process and a device that includes a computer readable medium having instructions for carrying out a process.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application and are within the scope of the following claims.

### Appendix A

### An Implementation of Selection of Redundant Slices

Suppose when the pre-coded bitstream is generated, multiple redundant pictures are coded for each input picture to provide different error resilience and bit rate tradeoffs. Therefore, for a given channel loss rate and bit rate constraint, it is possible to select a set of redundant slices to include into the final bitstream to maximize its error resilience capability.

The distortion of the received video can be divided into two parts: source distortion due to compression and channel distortion due to slice losses during transmission. A redundant slice is only used when its corresponding primary slice is not correctly received. Therefore, redundant slices only affect channel distortion.

Suppose an input video sequence has N pictures, and for picture n there are Kₙ different redundant slices in the pre-coded bitstream. By including a set Sₙ of redundant slices for picture n into the final bitstream, the expected channel distortion for the picture can be reduced and the amount of distortion reduction is denoted as E[ΔDₙ]. Note that minimizing the channel distortion for picture n is equivalent to maximizing E[ΔDₙ].

Assume that for each picture n, E[ΔDₙ] is approximately uncorrelated. The goal of the redundant slice selection can be written as

$$max {\sum }_{n = 1}^{N} E [ Δ {D}_{n} ] s . t . {\sum }_{n = 1}^{N} {R}_{n}^{( RCP )} \leq {R}_{T} - {\sum }_{n = 1}^{N} {R}_{n}^{( PCP )} \qquad ( 1 )$$

In the equation, R_{T} is the given rate constraint, Rₙ^{(PCP)} and Rₙ^{(RCP)} are the rates for the primary slice and the redundant slices for picture n, respectively. Furthermore, for a given slice loss rate p, E[ΔDₙ] can be expressed as

$$\begin{matrix}E [ Δ {D}_{n} ] = {\sum }_{i = 1}^{‖ {S}_{n} ‖} E [ Δ {D}_{n}^{i} ] \\ = {\sum }_{i = 1}^{‖ {S}_{n} ‖} {p}^{i} ( 1 - p ) ( {D}_{n}^{( PCP )} - {D}_{n , i}^{( RCP )} )\end{matrix} \qquad ( 2 )$$

where E[ΔDₙⁱ] is the expected distortion reduction brought by including the ith redundant slice from Sₙ. Furthermore, Dₙ^{(PCP)} is the distortion incurred when the primary slice is lost and Sₙ is an empty set. Similarly, D_{n,i}^{(RCP)} is the distortion incurred when the ith coded redundant slice in Sₙ is correctly decoded, but the primary slice as well as 1 to (i−1)th included redundant slices in the set are lost.

Directly solving the optimization problem posed by Eq. (1) and (2) can be difficult. Instead a greedy search algorithm is developed with low complexity. Similar to other greedy based algorithms, at each step the algorithm selects the best redundant slice in terms of the ratio between the distortion reduction and rate cost, until the given bit rate is used up. After a redundant slice is selected, the algorithm either adds it to the set as a new element, or replaces an existing redundant slice in the set with the new one if it produces larger expected distortion reduction.

Let P be a candidate redundant slice for position i of Sₙ for picture n. Denote its bit rate as R_{n,P}^{(RCP)}), and its corresponding E[ΔDₙⁱ] can be calculated as a term in Eq. (2). For each set Sₙ we assign a counter c to record the number of redundant slices that have been included. Finally, denote R_{T}^{(RCP)} as the total bit rate allocated to all the redundant slices. The detailed steps of the algorithm are listed below.
1. Initialization: ∀nε[1, N], set Sₙ to empty and its c to 0. Set R_{T}^{(RCP)} to R_{T}−Σₙ₌₁^{N}Rₙ^{(PCP)}.
2. For all the sets Sₙ (∀nε[1, N]), at positions i (iε{c, c+1} and i>0), select the redundant slice P which has the largest ratio between E[ΔDₙⁱ] and R_{n,P}^{(RCP)}, among all the candidate slices at the positions.
3. If R_{n,P}^{(RCP)}>R_{T}^{(RCP)}, exclude the redundant slice P as a candidate for the position i Sₙ. Go to Step 6.
4a. If i==c+1, include P at position i of Sₙ and exclude it as a candidate for the position. Set c to i and update R_{T}^{(RCP)} to R_{T}^{(RCP)}−R_{n,P}^{(RCP)}.
4b. Else if (i==c), which means the position i of Sₙ is already taken by another slice P′,
   1) If E[ΔDₙⁱ]_{P}>E[ΔDₙⁱ]_{P′}, then replace P′ with P at the position. Update R_{T}^{(RCP)} to R_{T}^{(RCP)}+R_{n,P′}^{(RCP)}−R_{n,P}^{(RCP)}.
   2) Exclude P as a candidate for the position.
5. If there is another available candidate redundant slice, go to Step 2; otherwise exit, and {Sₙ, ∀nε[1, N]} contains the set of the chosen redundant slices for the final bitstream.

To help clarify the operation of the above algorithm, the following example is provided in which only a single set needs to be filled. In the first round, the algorithm evaluates candidates for position 1 of the set. Note that the candidates for all positions are the same.

During the first round, we will assume that a candidate is selected in step 2 that also satisfies step 3. Position 1 is then tentatively filled with this candidate.

The algorithm then proceeds to a second round in which positions 1 and 2 of the set are evaluated simultaneously. Unlike the first round, the second round may involve multiple passes through the algorithm.

In the second round, the algorithm determines, in step 2, the candidate with the best ratio. In determining the best ratio, the algorithm evaluates (1) all candidates (except the tentatively selected candidate for position 1) based on the expected value of distortion reduction for position 1, and (2) all candidates based on the expected value of distortion reduction for position 2. The best from these “two” sets of candidates is selected in step 2. The selected candidate may be for either position 1 or position 2. This completes the first pass of the second round.

If the newly selected candidate is again for position 1, then the expected values of distortion reduction are compared in step 4b for the candidates that were selected in the first round and the second round (first pass). The candidate with the higher (better) value is tentatively selected for position 1, thereby possibly replacing the candidate tentatively selected in the first round. Further, the second round continues by performing a second pass through the algorithm. In the second pass, the algorithm (in step 2) evaluates the ratios of (1) all candidates (except the two previously selected candidates for position 1) based on the expected value of distortion reduction for position 1, and (2) all candidates based on the expected value of distortion reduction for position 2. It should be clear that the second round may require many passes through the algorithm. In each pass through the algorithm, the most-recently selected candidate for position 1), along with all other previously selected candidates (for position 1) is eliminated from further consideration in evaluations of ratios for position 1.

However, whenever the newly selected candidate from any pass of the second round is for position 2, position 2 is tentatively filled with the newly selected candidate. Also position 1 is deemed to be filled because the candidate (whether selected during the first round or the second round) will not be subject to further replacement. The algorithm then proceeds to a third round in which positions 2 and 3 are evaluated simultaneously.

Generally each picture can have a different impact on the channel distortion of the decoded sequence when the picture is lost. With the proposed algorithm, those pictures with larger ratios between E[ΔDₙⁱ]and R_{n,P}^{(RCP)}, or larger E[ΔDₙⁱ] values occupy more positions and, therefore, are given more bit rate for their redundant slices, hence receive stronger error protection. This forms unequal error protection (UEP) across the sequence and is a source of the performance gain provided by the algorithm.

Because the importance of each redundant slice can be different, the included redundant slices can be sorted according to their relative importance. Therefore, it is possible to group all the primary slices to form a base layer, and arrange all the redundant slices together with decreasing importance into enhancement layers. This forms a scalable bitstream in terms of error resilience, i.e., better error resilience capability can be achieved by including more enhancement layers of the bitstream. By forming the pre-coded bitstream error resilience scalability, the final bitstream can be obtained by simply truncating the pre-coded bitstreams according to a rate constraint. It simplifies the assembly process.

1. A method comprising:
receiving a request to send over a channel one or more encodings of at least a portion of a data object;
accessing information for determining which of multiple encodings of at least the portion of the data object to send over the channel; and
determining, after receiving the request, a set of encodings to send over the channel, the set being determined from the multiple encodings and including at least one of the multiple encodings, and the number of encodings in the determined set being based on the accessed information.

2. The method of claim 1 wherein the determined set of encodings includes one or more source-encodings, and the number of source-encodings in the determined set indicates a particular level of source-encoding redundancy.

3. The method of claim 1 wherein the at least one encoding in the determined set encodes a picture in a video sequence.

4. The method of claim 3 wherein the at least one encoding in the determined set is a lossy encoding of at least the portion of the data object.

5. The method of claim 3 wherein the determined set includes a primary encoding of the picture and a redundant encoding of the picture.

6. The method of claim 5 wherein the primary encoding is a primary-coded-picture and the redundant encoding is a redundant-coded-picture.

7. The method of claim 6 wherein the primary-coded-picture and the redundant-coded-picture are compatible with the H.264/AVC standard.

8. The method of claim 3 further comprising:
determining a second set of encodings to send over the channel, the second set being determined from multiple encodings of a second picture in the video sequence, and the number of encodings in the second determined set being based on the accessed information and possibly differing from the number of encodings in the determined set.

9. The method of claim 3 further comprising:
accessing second information for determining which of multiple encodings of a second picture in the video sequence to send over the channel; and
determining a second set of encodings to send over the channel, the second set being determined from multiple encodings of the second picture in the video sequence, and the number of encodings in the second determined set being based on the accessed second information and possibly differing from the number of encodings in the determined set.

10. The method of claim 1 further comprising storing the multiple encodings prior to receiving the request, and wherein determining the set comprises determining the set from the stored encodings.

11. The method of claim 1 wherein accessing the information comprises accessing information describing a channel condition for the channel.

12. The method of claim 1 wherein:
the accessed information comprises available capacity for the channel, and
determining the set comprises determining a set of encodings that can be sent over the channel within the available capacity.

13. The method of claim 1 wherein:
the accessed information comprises error rate for the channel, and
determining the set comprises including relatively fewer encodings in the set if the error rate is lower and including relatively more encodings in the set if the error rate is higher.

14. The method of claim 13 wherein:
the multiple encodings include multiple redundant slices for a given picture in a video sequence, and
determining the set further comprises including relatively fewer of the multiple redundant slices in the set if the error rate is lower and including relatively more of the multiple redundant slices in the set if the error rate is higher.

15. The method of claim 14 wherein:
the multiple redundant slices are compatible with the H.264/AVC standard,
the determined set includes at least one of the redundant slices, and
the method further comprises sending the determined set of encodings, including that at least one redundant slice, to a receiver in a form compatible with the H.264/AVC standard.

16. The method of claim 1 wherein the accessed information comprises one or more of (1) available capacity for the channel, (2) error rate for the channel, and (3) cost for transmitting over the channel.

17. The method of claim 1 wherein:
the multiple encodings are in an ordered set of encodings,
each encoding in the ordered set encodes at least the portion of the data object,
the encodings in the ordered set are ordered according to a metric related to quality of the encoding compared to original data encoded by the encoding, and
determining the set of encodings comprises determining a target encoding in the ordered set and including in the set all encodings from an endpoint of the ordered set up to an including the target encoding.

18. The method of claim 17 wherein:
the channel is a lossy channel, and
the encodings in the ordered set are ordered such that after a particular encoding in the ordered set has been sent to a device over the lossy channel, if the next encoding occurring after the particular encoding in the ordered set is also sent to the device over the lossy channel, an expected quality of a decoding by the device of at least the portion of the data object increases.

19. The method of claim 1 further comprising duplicating at least one of the multiple encodings, and wherein determining the set comprises including the duplicated encoding in the set.

20. A computer readable medium comprising instructions for causing one or more devices to perform the following:
receiving a request to send over a channel one or more encodings of at least a portion of a data object;
accessing information for selecting which of multiple encodings of at least the portion of the data object to send over the channel; and
selecting, after receiving the request, a set of encodings to send over the channel, the set being determined from the multiple encodings and including at least one of the multiple encodings, and the number of encodings in the determined set being based on the accessed information.

21. An apparatus comprising:
means for accessing information for selecting which of multiple encodings of at least a portion of a data object to send over a channel; and
means for selecting a set of encodings to send over the channel, the set being determined from the multiple encodings and including at least one of the multiple encodings, and the number of encodings in the determined set being based on the accessed information.

22. A selection unit configured to access information for determining which of multiple encodings of at least a portion of a data object to send over a channel, and to determine a set of encodings to send over the channel, the set being determined from the multiple encodings and including at least one of the multiple encodings, and the number of encodings in the determined set being based on the accessed information.

23. A method comprising:
providing information for determining which of multiple encodings of at least a portion of a data object to send over a channel; and
receiving a set of encodings over the channel, the set having been determined from the multiple encodings and including at least one of the multiple encodings, and the number of encodings in the set having been based on the provided information.

24. The method of claim 23 wherein:
the provided information comprises information describing a channel condition of the channel, and
the method further comprises determining the information that describes the channel condition based on data received over the channel.
